(19) United States
(12) Patent Application Publication
(10) Pub. No.: US 2004/0074980 A1
(43) Pub. Date: Apr. 22, 2004

(54) Method and device for generating a liquid mist

(76) Inventor: Anders Ekelof, Onsala (SE)

Correspondence Address: JACOBSON HOLMAN PLLC, 400 SEVENTH STREET N.W., SUITE 600, WASHINGTON, DC, 20004, US

(21) Appl. No.: 10/471,595

(22) PCT Filed: Mar. 22, 2002
(86) PCT No.: PCT/SE02/00581

(30) Foreign Application Priority Data
Mar. 23, 2001 (SE) 0101041-2

(51) Int. Cl. A01G 15/00

(52) U.S. Cl. 239/2.1

(57) ABSTRACT

The invention relates to a device and a method for generating a mist for camouflaging ships, vehicles, air vehicles and stationary objects within infrared and radar wavelengths. It known to use mist, for instance water mist, to camouflage an object or to produce a decoy. The object of the invention is to generate mist in a more efficient way and to design a simpler device than before. The device according to the invention generates mist (3) by a liquid (2), for instance water, being injected into a flow of air (1), which is supplied from an air duct (10), through a nozzle (21) directed towards the flow of air (1).

The present invention relates to a method and a device for generating a liquid mist for camouflage of, inter alia, ships, land vehicles, air vehicles and stationary objects, and as decoy within the infrared and radar wavelengths.

It is known that mist, for instance water mist, can be used to camouflage an objector to produce decoys. If an object is covered by water mist, it will be difficult to discover by IR measurement and radar. By controlling temperature and/or size of droplets of the liquid used to generate the mist, it is possible to produce not only camouflage but also a mist which is an effective decoy for radar or IR homing devices.

Known devices for generating mist are using nozzles to atomise the liquid and spread the mist. Liquid under high pressure is used to produce the droplets that are necessary. Patent Specification EP 0 221 469 B discloses an example of a device for producing a decoy or camouflage by generating a mist. In this device, the mist is generated by means of water projectors provided with atomiser nozzles. The liquid is ejected intermittently through the nozzles. A drawback of intermittent spreading of mist is that there is a risk that a first layer of mist has time to drift away before the next layer has been positioned, which increases the risk of discovery.

German Patent Specification DE 37 06 781 A1 discloses a device for generating and spreading a continuous water mist, comprising a plurality of pairs of nozzles consisting of one nozzle for atomising of liquid and one nozzle arranged at an angle thereto and intended for compressed air. Water is ejected through the atomiser nozzle in the form of a layer of water droplets. This layer is hit by a flow of air from the compressed air nozzle, whereby the layer is spread and forms a mist.

Prior-art technique of generating mist by means of atomiser nozzles, however, suffers from several deficiencies. It takes quite a long time to produce a complete mist, thus requiring a long forewarning time in case of an attack by, for example, homing missiles. An atomiser nozzle generates mist having a predetermined droplet size. The droplet size is most important to the capability of the mist to camouflage an object. A mist intended to make an object invisible to an IR homing device gives poor protection against a radar homing device and vice versa. Therefore at least two types of atomiser nozzles are frequently used, one generating an IR mist and one generating a radar mist: a method requiring much space and making the device expensive. Moreover the device requires a water pressure of 250-300 bar to produce the desired size of droplets, which results not only in a high water and power consumption but also places great demands on pipes, connections and the like. In cold weather, there is also a risk of the atomiser nozzles being clogged by ice and the protected object being covered with ice. There is also a risk that the atomiser nozzles are clogged by dirt particles, especially in cases where the water used is lake water or sea water. This makes it necessary to include price increasing devices for filtering of water in the mist-generating device. Moreover, atomiser nozzles are poor at spreading the generated mist, which makes it necessary to use a plurality of nozzles to generate a sufficient layer of mist also for a small object. All in all, this results in a mist-generating device having a high water and power consumption and including a great number of large and heavy components.

The object of the present invention is to generate and spread mist in a more efficient way and to design a simpler device than before. A further object is to provide droplets without using space-requiring and heavy installations to produce high water pressures.

The above objects are achieved by a method and a device according to claims 1 and 9.

The invention will now be described in more detail by way of embodiments and with reference to the accompanying drawings, in which

FIG. 1 is a top plan view of a ship equipped with the invention,

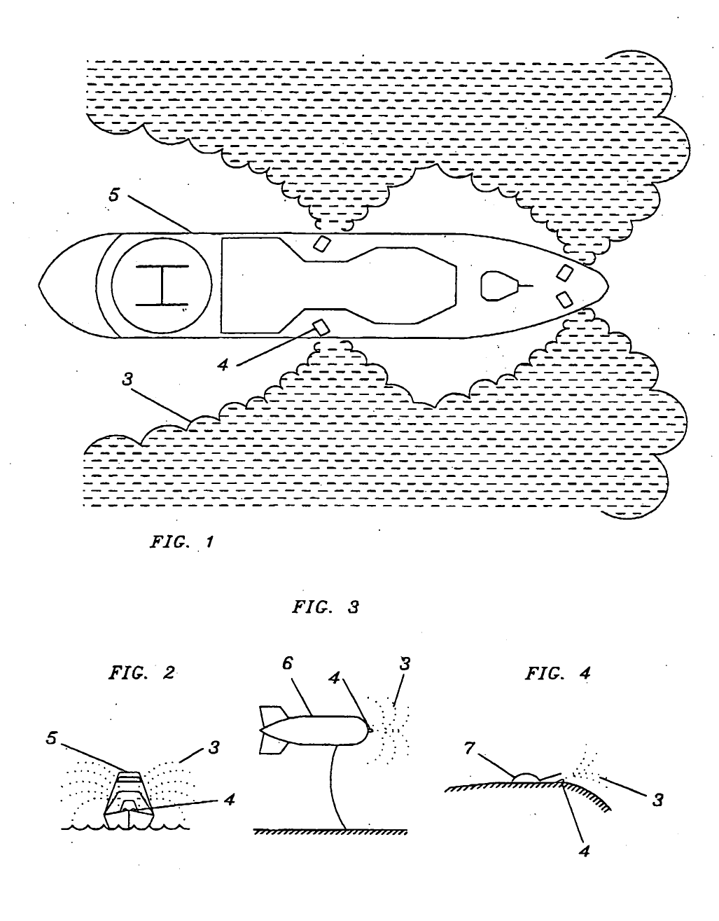

FIG. 2 shows a ship equipped with the invention,

FIG. 3 shows the invention on an air vehicle,

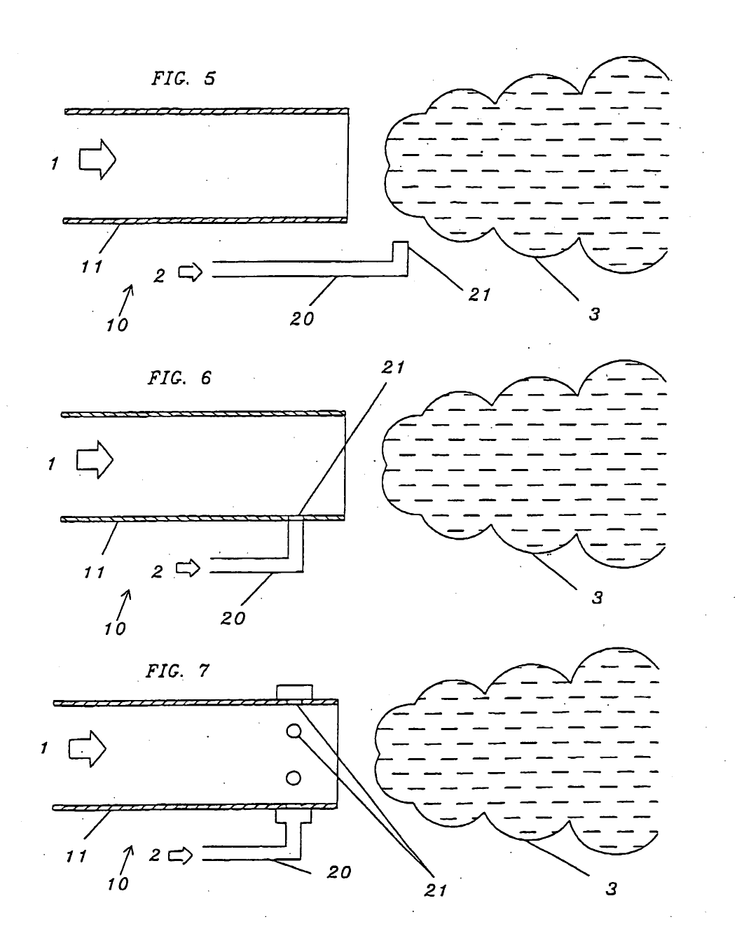

FIG. 4 shows the invention adjacent to a stationary object,

FIG. 5 shows a first embodiment of the invention,

FIG. 6 shows a second embodiment of the invention, and

FIG. 7 shows a third embodiment of the invention.

FIG. 1 shows a ship (5) equipped with a device (4) for generating and spreading mist according to the invention. The device (4) spreads mist (3) round the ship (5). Conveniently the water round the ship is used as liquid to generate the mist (3).

FIG. 2 shows from the front how a ship (5) equipped with a mist-generating device (4) spreads a mist (3). FIG. 3 shows an air vehicle, in this case an aerostat (6), equipped with a mist-generating device (4). Also helicopters, slow aircraft and ground vehicles, such as combat and transport vehicles, can be quipped with mist-generating devices. In these cases, the supply of liquid is not unlimited, as when used on a ship. At the same time the limitations as to space and weight are narrow. Therefore a light and small mist-generating device with a low consumption of liquid, a few litres per minute, is important. FIG. 4 shows a mist-generating device (4) adjacent to a stationary object, for instance artillery (7), bridges, depots and warehouses.

According to the invention, a hot or cold liquid is injected into a flow of air (hot or cold). The flow of air should be strong, at least 30 m/s, but preferably significantly stronger (up to 277 m/s). When the liquid enters the flow of air, the liquid droplets will be atomised. The liquid droplets then continue with the flow of air and form a mist. By varying the speed of the flow of air, the size of the liquid droplets can be affected. An indication of an approaching threat involving a radar homing device results in the liquid droplets of the mist being adjusted to camouflage the object for precisely the radar frequencies in question. Correspondingly, an IR threat results in generation of a special IR mist which camouflages wavelengths within the infrared range. The size and power of absorption of the droplets and, thus, the spectral properties of the mist can also be affected by the design of the air duct, the liquid pressure, additives and the design of the nozzles. For instance, water, optionally with an alkali metal added, for instance sodium, can be used to increase the temperature of the mist still more, or electromagnetically reflecting substances, for instance metal powder, to produce a decoy.

FIGS. 5-7 illustrate different embodiments of the invention. FIG. 5 shows an air duct (10) consisting of a pipe (11) through which a strong flow of air (1) passes. Immediately after the flow of air (8) has left the pipe (11), liquid (2) is injected from a nozzle (21) into the flow of air (1). The flow of air (1) which has a high speed, above 30 m/s, atomises the injected liquid in droplets and spreads the droplets which form a mist (3).

FIG. 6 illustrates an embodiment where the liquid (2) is injected into the flow of air (1) before the flow of air has left the pipe (11). FIG. 7 shows a third embodiment where a number of nozzles (21) are arranged in the pipe (11). The nozzles need

not be arranged in the wall of the pipe but may also be arranged inside the pipe, for instance one nozzle arranged in the centre of the pipe and the flow of air or a plurality of nozzles arranged concentrically in the flow of air.

The invention presents a number of advantages compared with prior art. Among other things, the liquid is atomised in two steps, first through the nozzle (21) and then through further atomising in the flow of air (1) instead of in an atomiser nozzle, like in prior-art solutions. Therefore an atomiser nozzle is not necessary, but may be used, which means that the liquid pressure can be considerably lower and that the risk of clogging of the nozzle owing to dirt particles in the liquid decreases. Moreover, the flow of air is used to spread the mist in an efficient manner. The flow of air (1) is conducted in an air duct (10) which has a great exhaust capacity and manages a considerably greater flow of air than a nozzle. The device according to the invention can spread mist in a more efficient manner using a considerably smaller number of components compared with prior art. As a result, the weight of the device will be relatively low compared to the generated amount of mist, and only one or a few exhaust means are required. It will also be possible to use a lower water pressure, which means that the power requirement is smaller.

As illustrated in FIGS. 1-4, the invention can be used on many different vehicles and objects. Particularly those that are already equipped with exhaust means, for instance exhaust pipes or ventilation, can without much modification and in an inexpensive manner be equipped with protection that has so far been reserved for large vehicles and installations. The advantage of using the invention in connection with exhaust pipes and the like is, in addition to a camouflaging mist, that the exhaust gases are cooled, thus reducing the IR signature of the vehicle still more. The lower liquid pressure also makes it possible to use water from an existing sprinkler installation or the like. Moreover, the low water consumption of the device implies that also smaller vehicles, such as combat and transport vehicles, can carry a sufficient amount of liquid to provide an effective camouflaging mist.

1. A method of generating a mist (3) to provide camouflages or decoys by:
a liquid (2) being injected into a flow of air (1);
characterised in that
the flow of air (1) is generated in an air duct (10);
the flow of air (1) atomises the liquid (2) into droplets of desired size and, spreads the droplets as a mist (3).

2. A method as claimed in claim 1, characterised in that the flow of air (1) has a speed of at least 30 m/s where the liquid is injected.

3. A method as claimed in claim 1 or 2, characterised in that the liquid (2) has a pressure of less than 100 bar, preferably 0-50 bar.

4. A method as claimed in any one of claims 1-3, characterised in that the liquid (2) is a injected through one or more nozzles (21) into the air duct (10).

5. A method as claimed in any one of claims 14, characterised in that the size of the liquid droplets is controlled by the speed of the flow of air.

6. A method as claimed in any one of claims 1-5, characterised In that the liquid (2) essentially consists of water with or without substances which, for instance, affect the absorption properties of the mist, the coherence of the liquid or the freezing point of the liquid.

7. A method as claimed in any one of claims 1-6, characterised in that the flow of air (1) has a speed of at least 30 m/s, preferably 30-150 m/s, and that the liquid has a pressure of less than 20 bar, preferably 3-10 bar.

8. A device for generating a mist (3) to provide camouflage, characterised in that the device comprises an air duct (10) conducting a flow of air (1), and a nozzle (21) directed towards the flow of air (1) to inject a liquid (2) into the flow of air (1) for atomising the liquid into droplets of desired size and spreading of the droplets.

9. A device as claimed in claim 8, characterised in that the nozzle (21) injects the liquid (2) into the flow of air (1) after the flow of air has left the air duct (10).

10. A device as claimed in claim 8, characterised in that the nozzle (21) injects the liquid into the flow of air (1) before the flow of air (1) leaves the air duct (10).

11. A device as claimed in claim 10, characterised in that the nozzle (21) is arranged in the wall (11) of the air duct.

12. A device as claimed in any one of claims 8-11, characterised in that the liquid (2) has a pressure of less than 20 bar, preferably 3-10 bar.

13. A device as claimed in any one of claims 8-12, characterised in that the flow of air (1) has a speed of at least 30 m/s, preferably 30-150 m/s.

14. A device as claimed in any one of claims 8-13, characterised in that the liquid (2) is injected through one or more nozzles (21).

15. A device as claimed in any one of claims 8-14, characterised in that the speed of the flow of air determines the spectral properties of the mist.
